(19) United States
(12) Patent Application Publication
(10) Pub. No.: US 2016/0242072 A1
(43) Pub. Date: Aug. 18, 2016

(54) HANDLING OVER-SIZED CALL SETUP MESSAGES

(71) Applicant: QUALCOMM Incorporated, San Diego, CA (US)

(72) Inventors: Liangchi Hsu, San Diego, CA (US); Sitaramanjaneyulu Kanamarlapudi, San Diego, CA (US); Sivasubramanian Ramalingam, Hyderabad (IN); Yongsheng Shi, San Diego, CA (US); Vikas Gulati, Hyderabad (IN); Sathish Krishnamoorthy, Hyderabad (IN)

(21) Appl. No.: 14/831,649

(22) Filed: Aug. 20, 2015

Related U.S. Application Data
(60) Provisional application No. 62/117,843, filed on Feb. 18, 2015.

(51) Int. Cl. H04W 28/06; H04W 76/02; H04W 28/02

(52) U.S. Cl. CPC H04W 28/06; H04W 28/0289; H04W 76/02

(57) ABSTRACT

Methods, systems, and devices are described for handling over-sized call setup messages are disclosed. A user equipment (UE) may identify the size of a connection setup message (e.g., RRC connection setup complete message) associated with one or more UE capability information. Based on the identified size of the connection setup message, the UE may determine an estimated time required to transmit the connection setup message to a network entity (e.g., base station) over at least one uplink channel and determine whether the estimated time is above or below a threshold. If the UE determines that the estimated time to transmit the connection setup message is greater than the threshold, the UE may remove at least a portion of the connection setup message and transmit a modified connection setup message.

### CROSS-REFERENCE TO RELATED APPLICATION(S)

This application claims priority to U.S. Provisional Application Ser. No. 62/117,843, entitled, “APPARATUS AND METHOD FOR HANDLING OVER-SIZED CALL SETUP MESSAGES,” and filed on Feb. 18, 2015, which is assigned to the assignee hereof and hereby expressly incorporated by reference herein in its entirety.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., an LTE system).

By way of example, a wireless multiple-access communications system may include a number of base stations, each simultaneously supporting communication for multiple communication devices, which may be otherwise known as user equipment (UEs), mobile devices or stations (STAs). A base station may communicate with the communication devices on downlink channels (e.g., for transmissions from a base station to a UE) and uplink channels (e.g., for transmissions from a UE to a base station).

Conventionally, UEs may report UE capability during radio resource control (RRC) connection establishment. In addition to the full set of UE capability sent in RRC connection setup complete message (which may be used for the proper set up of data radio bearers and measurement control configuration), UE may also report a small set of capabilities in RRC connection request messages (e.g., as initial information to radio network controller (RNC) to properly setup signaling radio bearers). However, the size of UE capability information sent in RRC connection setup complete message may vary in the current 3GPP standard based on one or more capabilities supported by modem UEs. For example, a multi-mode UE configured to support multiple radio access technologies (RATs) for communication over multiple frequency bands (e.g., licensed and unlicensed spectrum) may cause large signaling overhead due to reporting of a full set of UE capabilities. Therefore, in some conventional examples, the large signaling overhead may affect call setup delays associated with RRC connection establishment.

### SUMMARY

Systems, methods, and apparatuses for handling over-sized call setup messages are disclosed. In some aspects, for example, a UE may identify the size of a connection setup message (e.g., RRC connection setup complete message) associated with one or more UE capability information. Based on the identified size of the connection setup message, the UE may determine an estimated time required to transmit the connection setup message to a network entity (e.g., base station) over at least one uplink channel and determine whether the estimated time is greater than or less than a threshold. If the UE determines that the estimated time to transmit the connection setup message is greater than the threshold, the UE may remove at least a portion of the connection setup message and transmit a modified connection setup message. In some examples, the modified connection setup message may be a partial connection setup message where one or more UE capability information has been removed from the connection setup message. Additionally or alternatively, in some aspects of the present disclosure, the UE, upon establishing an RRC connection with the network entity, may initiate UE capability enquiry to advertise the complete UE capabilities to the network.

According to a first aspect, a method for wireless communications is described. The method may include identifying, at a UE, a size of a connection setup message and calculating, at the UE, an estimated time for transmitting the connection setup message based at least in part on the size of the connection setup message. The method may further include determining whether the estimated time is greater a threshold and trimming a portion of the connection setup message for transmitting based on the determination that the estimated time is greater than the threshold.

According to a second aspect, an apparatus for wireless communication is described. The apparatus may comprise means for identifying, at a UE, a size of a connection setup message and means for calculating, at the UE, an estimated time for transmitting the connection setup message based at least in part on the size of the connection setup message. The apparatus may further include means for determining whether the estimated time is greater than a threshold and means for trimming a portion of the connection setup message for transmitting based on the determination that the estimated time is greater than the threshold.

According to a third aspect, a computer readable medium storing computer executable code for wireless communication is disclosed. The computer readable medium may comprise code for identifying, at a UE, a size of a connection setup message and code for calculating, at the UE, an estimated time for transmitting the connection setup message based at least in part on the size of the connection setup message. The computer readable medium may further include code for determining whether the estimated time is greater a threshold and code for trimming a portion of the connection setup message for transmitting based on the determination that the estimated time is greater than the threshold.

According to a fourth aspect, yet another apparatus for wireless communication is disclosed. The apparatus may include a transceiver configured to transmit uplink data transmissions on an uplink channel, and to receive responses corresponding to the uplink data transmissions. The apparatus may also include a memory configured to store code with instructions and at least one processor communicatively coupled to the memory and the transceiver via a bus. The at least one process may be configured to identify, at a user equipment (UE), a size of a connection setup message and calculate, at the UE, an estimated time for transmitting the connection setup message based at least in part on the size. The processor may further determine whether the estimated time is greater than a threshold and trim a portion of the connection setup message for transmitting based on the determination that the estimated time is greater than the threshold.

To the accomplishment of the foregoing and related ends, the one or more aspects of the present disclosure comprise the features hereinafter fully described and particularly pointed out in the claims. The following description and the annexed drawings set forth in detail certain illustrative features of the one or more aspects of the present disclosure. These features are indicative, however, of but a few of the various ways in which the principles of various aspects of the present disclosure may be employed, and this description is intended to include all such aspects and their equivalents.

### BRIEF DESCRIPTION OF THE DRAWINGS

The disclosed aspects of the present disclosure will hereinafter be described in conjunction with the appended drawings, provided to illustrate and not to limit the disclosed aspects, wherein like designations denote like elements, where a dashed line may indicate an optional component, and in which:

FIG. 1A is a schematic diagram of a communication network including an aspect of a UE that may manage over-sized call setup messages in accordance with various aspects of the present disclosure;

FIG. 1B is a schematic diagram of communication management component configured to perform one or more aspects of the present disclose;

FIG. 2 shows a flowchart illustrating a method for managing over-sized call setup messages in accordance with various aspects of the present disclosure; and

FIGS. 3A and 3B show a flowchart illustrating a method for managing over-sized call setup messages in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It should be understood, however, that such aspect(s) may be practiced without these specific details. In an aspect, the term “component” as used herein may be one of the parts that make up a system, may be hardware, firmware, and/or software, and may be divided into other components.

In some aspects, at radio resource control (RRC) connection setup, a UE may send UE radio access capability information as part of the RRC setup complete message to the radio network controller (RNC). UE capability information may include UE radio capabilities, UE non-access stratum (NAS) capabilities, and classmark information. In some aspects, UE radio capabilities include UE global system for mobile communications (GSM)/enhanced data rates for GSM evolution (EDGE) radio access network (GERAN) capability, UE universal terrestrial radio access network (UTRAN) capability and UE evolved universal terrestrial radio access network (E-UTRAN) capability. Additionally or alternatively, UE NAS capabilities may include UE network capability and mobile switching (MS) network capability. In the 3GPP standard, a UE may report radio capability information during the RRC connection establishment. In some examples, a UE, in addition to reporting a full set of UE radio capability information in the RRC connection setup complete message, may also report a small set of additional UE capabilities (e.g., Full-Duplex/Half-duplex UE capabilities) that may be used to properly setup signaling radio bearers. Accordingly, in some examples, the size of the UE capability information sent in the RRC setup complete message may vary significantly (e.g., between 98 bytes and 1954 bytes) depending on the type and the amount of UE capabilities that UE may report during the RRC connection establishment procedure.

The size of the UE capability information in the connection setup message (e.g., RRC setup complete message) may correspond with the delay in establishing RRC connection. For example, UEs are generally configured for multi-mode communications. Thus, in some aspects, for example, the size of the connection setup message associated with a multi-mode UE advertising its complete set of capabilities may be as large as 1954 bytes that may require approximately 1.5 to 3 seconds to transmit to the network (e.g., radio network controller). Conversely, for example, the size of the connection setup message for a UE advertising only a portion of its capabilities may be as small as 98 bytes that may be transmitted in as little as 140 milliseconds (ms).

Accordingly, the disparity between the estimated times for transmitting a complete UE capability information versus transmitting only a portion of the UE capabilities may account for substantial delay in successfully completing the RRC connection establishment procedures. In accordance with the present disclosure, a system and method are provided for identifying, at the UE, a size of a connection set up message (e.g., RRC connection setup complete message) and calculating an estimated time for transmitting the connection setup message to the network entity. For the purposes of the present disclosure, terms “RRC connection setup message” and “RRC connection setup complete message” may be used interchangeably. In some aspects, if the UE determines that the estimated time exceeds or is greater than a threshold, the UE may remove or trim a portion of the connection setup message (e.g., one or more UE capability information elements) and transmit a partial or modified connection setup message in order to reduce the delay in completing the RRC connection procedures. Alternatively, if the UE determines that the estimated time to transmit a complete connection set up message is less than the predetermined threshold, the UE may transmit the connection setup message without modifying the connection setup message.

Referring to FIG. IA, in an aspect, a wireless communication system 10 includes at least one user equipment (UE) 115 in communication coverage of at least one network entity 105 (e.g., base station or node B). UE 115 can communicate with a network 18 via network entity 105 and a radio network control (RNC) 16. In an aspect, UE 115 may include one or more processors 20 that may operate in combination with communication management component 30 operable to identify, at the UE 115, a size of a connection set up message (e.g., RRC connection setup complete message) and calculate an estimated time for transmitting the connection setup message to the network entity. If the communication management component 30 determines that the estimated time exceeds a threshold, the communication management component 30 may remove a portion of the connection setup message (e.g., one or more UE capability information elements) and transmit a partial connection setup message in order to reduce the delay in completing the RRC connection procedures.

In an aspect, the network entity 105 may be a base station such a NodeB in an UMTS network. UE 115 may communicate with a network 18 via network entity 14 and a radio network controller (RNC) 16. In some aspects, multiple UEs including UE 115 may be in communication coverage with one or more network entities, including network entity 14. In an example, UE 115 may transmit and/or receive wireless communications to and/or from network entity 105.

In some aspects, UE 115 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, a global positioning system (GPS) device, a multimedia device, a video device, a digital audio player (e.g., MP3 player), a camera, a game console, a wearable computing device (e.g., a smart-watch, smart-glasses, a health or fitness tracker, etc), an appliance, a sensor, a vehicle communication system, a medical device, a vending machine, a device for the Internet-of-Things, or any other similar functioning device. Additionally, network entity 105 may be a macrocell, picocell, femtocell, relay, Node B, mobile Node B, UE (e.g., communicating in peer-to-peer or ad-hoc mode with UE 115), or substantially any type of component that can communicate with UE 115 to provide wireless network access at the UE 115.

The wireless communications between the UE 115 and the network entity 105 may include signals transmitted by either the network entity 105 or the UE 115. The wireless communications can include downlink channels transmitted by the network entity 14. For example, the network entity 14 may transmit a high-speed downlink shared channel (HS-DSCH), high-speed physical downlink shared channel (HS-PDSCH), downlink dedicated physical control channel (DL-DPCCH), or a fractional dedicated physical channel (F-DPCH).

In an aspect, the one or more processors 20 can include a modem that uses one or more modem processors. The various functions related to communication management component 30 may be included in modem and/or processors 103 and, in an aspect, can be executed by a single processor, while in other aspects, different ones of the functions may be executed by a combination of two or more different processors. For example, in an aspect, the one or more processors 20 may include any one or any combination of a modem processor, or a baseband processor, or a digital signal processor, or a transmit processor, or a transceiver processor associated with transceiver 60. In particular, the one or more processors 20 may execute functions and components included in communication management component 30.

In some examples, the communication management component 30 may include a UE capability component 32 configured to identify one or more capabilities supported by the UE 115. The UE capability component 32 may comprise hardware, firmware, and/or software and may be configured to execute code or perform instructions stored in a memory (e.g., a computer-readable storage medium). In some aspects, the UE capability component 32 may generate connection setup messages based on identification of the one or more UE capabilities supported by the UE 115. The connection setup messages may include one or more UE capability information elements to advertise UE capabilities to the network 18. In yet further examples, the UE capability component 32 may additionally determine the size (e.g., in bytes) of the connection setup message.

In some aspects, the communication management component 30 may additionally include a transmission estimation component 34 configured to estimate an amount of time required to transmit a connection setup message to the base station 105. The transmission estimation component 34 may comprise hardware, firmware, and/or software and may be configured to execute code or perform instructions stored in a memory (e.g., a computer-readable storage medium). In some examples, transmission estimation component 34 may additionally determine the configuration of at least one uplink transport channel (e.g., communication link 23/24), which may be used to transmit the connection setup message. The transmission estimation component 34 may additionally calculate the estimated time based on the size of the connection setup message and the channel quality (or configuration) of the uplink transport channel.

In some examples, the communication management component 30 may further include a threshold determination component 36 for determining whether the estimated transmission time calculated by the transmission estimation component 34 is greater or less than a threshold. In some examples, the threshold may be a predetermined threshold or dynamically adaptable threshold. Accordingly, the threshold determination component 36 may include an adjustment component for adjusting at least one threshold. The threshold determination component 36 may comprise hardware, firmware, and/or software and may be configured to execute code or perform instructions stored in a memory (e.g., a computer-readable storage medium). In some examples, the threshold may be adjusted based on the type of call setup. For example, the threshold determination component may select a first threshold value for a non-emergency call setup and a second threshold value for an emergency call setup, where the first threshold value and the second threshold value may be different.

In yet further examples, the communication management component 30 may include a message trimming component 38. The message trimming component 38 may comprise hardware, firmware, and/or software and may be configured to execute code or perform instructions stored in a memory (e.g., a computer-readable storage medium). The message trimming component 38 may be configured to trim the connection setup message for transmitting based on the determination that the estimated time is greater than the threshold. In some aspects, the message trimming component 38 may trim a portion of the connection setup message based on the determining that the estimated time is greater than the threshold. In some examples, trimming the portion of the connection setup message may comprise removing at least one of the identified UE capability information from the connection setup message. Trimming may also comprise selecting one or more portions of the UE capability information from the connection setup message for transmission to the base station 105. In this regard, the unselected portion of the of the UE capability information in the connection setup message is not transmitted to the base station 105. Additionally or alternatively, in some examples, trimming the portion of the connection setup message may comprise removing UE evolved universal terrestrial radio access (E-UTRA) capability information element from the RRC connection setup complete message. Thus, in one aspect, for example, at least a portion of UE capability may not be reported in modified connection setup message.

Moreover, in an aspect, UE 115 may include RF front end 61 and transceiver 60 for receiving and transmitting radio transmissions, for example, wireless communications 20 transmitted by the network entity 14. For example, transceiver 60 may receive a packet transmitted by the network entity 14. UE 12, upon receipt of an entire message, may decode the message and perform a cyclic redundancy check (CRC) to determine whether the packet was received correctly. For example, transceiver 60 may communicate with modem 108 to transmit messages generated by communication management component 30 and to receive messages and forward them to communication management component 30.

RF front end 61 may be connected to one or more antennas 64 and can include one or more switches 65, one or more amplifiers (e.g., power amplifiers (PAs) 64 and/or low-noise amplifiers 66), and one or more filters 67 for transmitting and receiving RF signals on the uplink channels and downlink channels In an aspect, components of RF front end 61 can connect with transceiver 60. Transceiver 60 may connect to one or more modems 108 and processor 20.

Transceiver 60 may be configured to transmit (e.g., via transmitter radio 62) and receive (e.g., via receiver radio 63) and wireless signals through antenna 64 via RF front end 61. In an aspect, transceiver may be tuned to operate at specified frequencies such that UE 115 can communicate with, for example, network entity 105. In an aspect, for example, modem 108 can configure transceiver 106 to operate at a specified frequency and power level based on the UE configuration of the UE 115 and communication protocol used by modem.

UE 115 may further include a memory 44, such as for storing data used herein and/or local versions of applications or communication management component 30 and/or one or more of its subcomponents being executed by processor 20. Memory 44 can include any type of computer-readable medium usable by a computer or processor 20, such as random access memory (RAM), read only memory (ROM), tapes, magnetic discs, optical discs, volatile memory, non-volatile memory, and any combination thereof. In an aspect, for example, memory 44 may be a computer-readable storage medium that stores one or more computer-executable codes defining communication management component 30 and/or one or more of its subcomponents, and/or data associated therewith, when UE 115 is operating processor 20 to execute channel messaging component 30 and/or one or more of its subcomponents. Additionally or alternatively, the UE 115 may include a bus 11 for coupling the RF front end 104, transceiver 106, memory 130 and processor 103 and to exchange signaling information between each of the components and/or subcomponents of the UE 12.

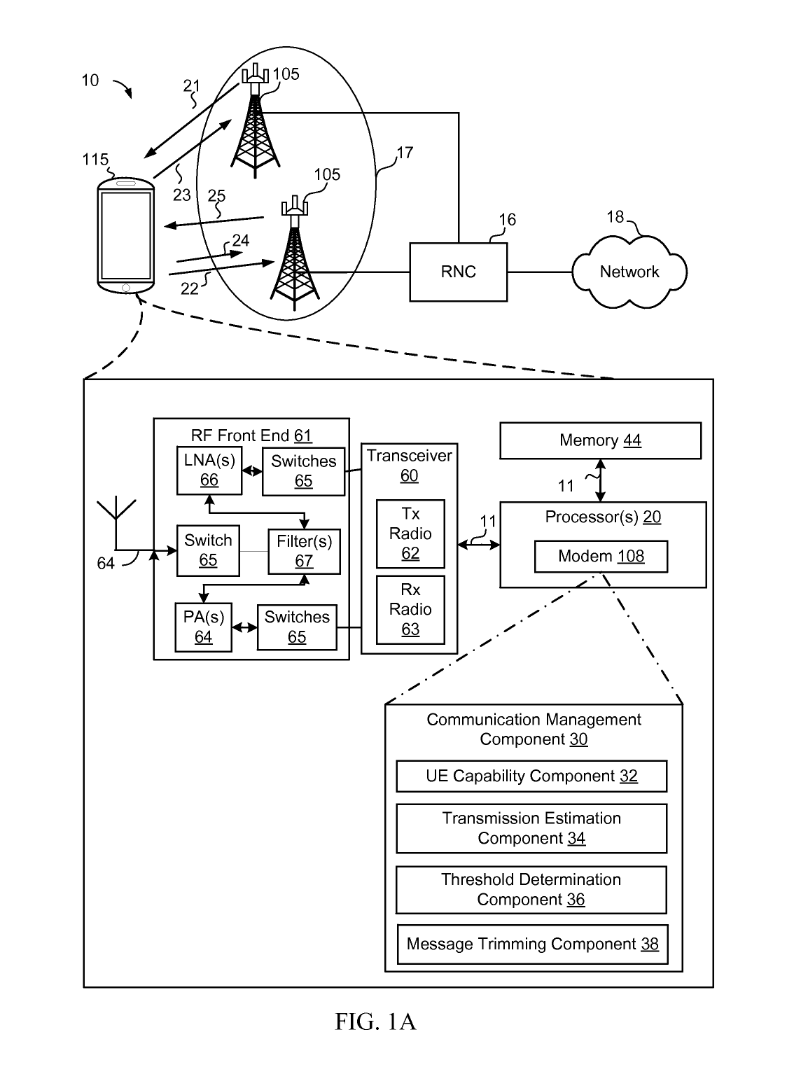

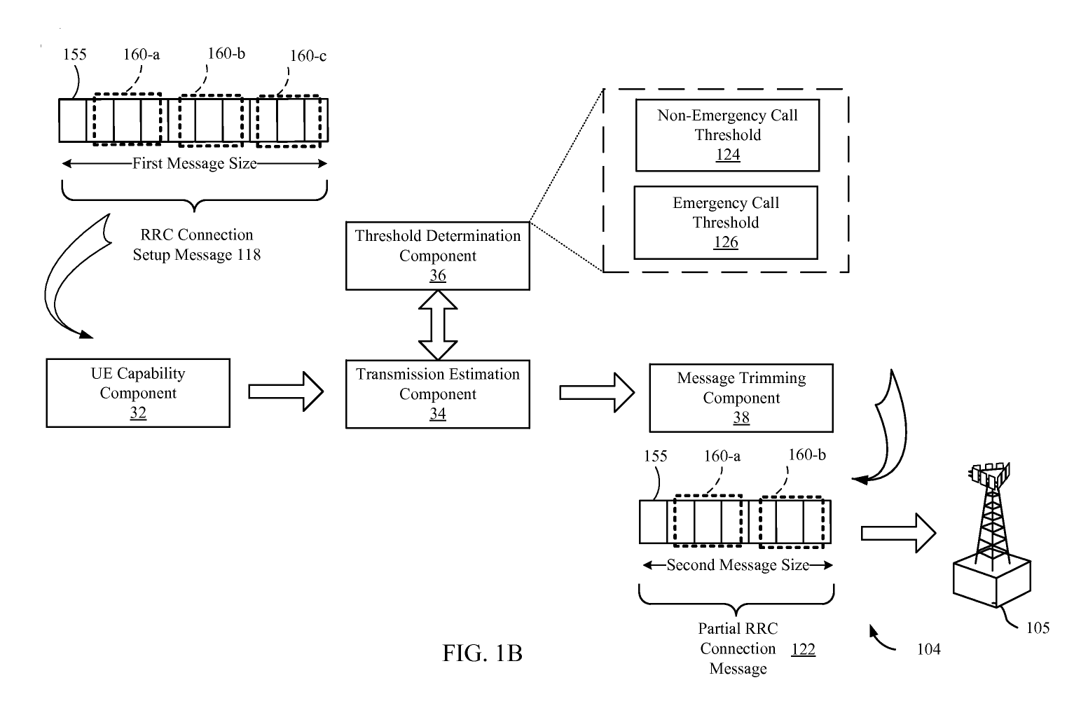

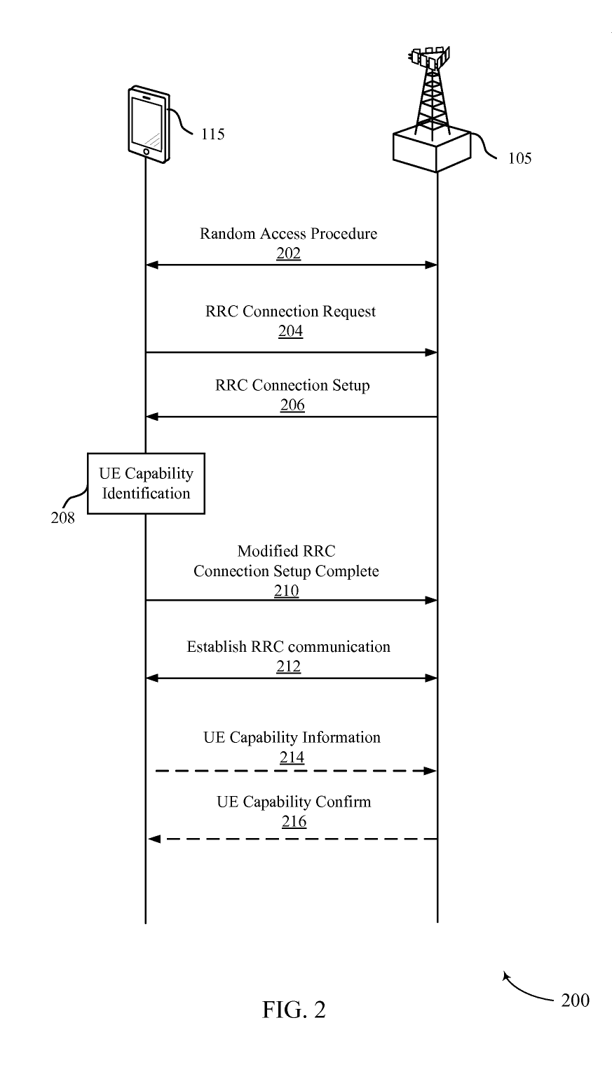

FIG. 1B illustrates an example of the communication management component 30 processing an RRC connection setup message for transmission to the base station 105 in accordance with various aspects of the present disclosure. In one example, the system 104 may include first RRC connection setup message 118 having a message format including a message type 155 and one or more UE capability information elements 160. Information elements may be one or more bits of information a message format identifying the respective capabilities of the UE. The first RRC connection setup message 118 may be generated by the UE 115 in response the UE 115 receive RRC connection setup message (See FIG. 2) from the base station 105. In some aspects, an RRC connection setup message may be a type of connection setup message. However, it should be appreciated that the features of the present disclosure are not limited exclusively to RRC connection setup message(s). Specifically, aspects of the present disclosure may be applied to other message types to reduce transmission delays for delay-sensitive messages.

In some examples, the UE capability component 32 may determine the size of the first RRC connection setup message 118 (e.g., first message size) based on the one or more UE capabilities supported by the UE 115. The message size information may be forwarded to the transmission estimation component 34 for estimating an amount of time required to transmit a connection setup message (e.g., first RRC connection setup message 118) that includes one or more UE capability information elements 160 to the base station 105. Upon estimating the amount of time required to transmit the connection setup message, the transmission estimation component 34 may reference the threshold determination component 36 to determine whether the estimated time is greater or less than a threshold value. The threshold value may include a first threshold value associated with a non-emergency call(s) and referred to as a non-emergency call threshold 124, and a second threshold value associated with the emergency call(s) and referred to as an emergency call threshold 126. Accordingly, if the transmission estimation component 34 determines that the estimated time for transmitting the first RRC connection setup message 118 is less than the threshold, the UE 115 may transmit the first RRC connection setup message 118 without trimming or removing any portion of the RRC connection setup message 118. However, if the transmission estimation component 34 determines that the estimated time for transmitting the first RRC connection setup message 118 is greater than or exceeds the threshold, the message trimming component 38 may trim or remove at least a portion of the first RRC connection setup message 118 such that the estimated amount of time to complete the transmission is less than or equal to the threshold. In some examples, trimming the portion of the first RRC connection setup message 118 may include removing at least one UE capability information (e.g., E-UTRA capability information 160-c) from the first RRC connection setup message 118 to produce a second partial RRC connection setup message 122. In some aspects, the size of the second partial RRC connection setup message 122 may be less than the size of the first RRC connection setup message 118. As such, the time to transmit the second partial RRC connection setup message 122 to the base station 105 may be less than the estimated time for transmitting the first RRC connection setup message 118.

FIG. 2 shows a flowchart illustrating a method 200 between a UE 115 and a base station 105 for handling over-sized call setup messages in accordance with various aspects of the present disclosure. In some examples, the UE 115 may be an example of UE 115 described with reference to FIG. 1. Additionally or alternatively, the base station 105 may be an example of base station 105 described with reference to FIG. 1. Although FIG. 2 is described with reference to the base station 105, it should be appreciated that the UE 115 may communicate with any network entity over one or more radio access technologies (RATs) supported by the UE 115.

In accordance with aspects of the present disclosure, UE 115 may include a communication management component 30 (see FIG. 1A) for establishing RRC connection between the UE 115 and the base station 105. In some examples, the communication management component 30, at 202, may initiate the RRC connection setup utilizing the defined random access procedures. In some examples, the UE 115 (that may have previously been in an idle mode), at 204, may transmit an RRC connection request message to the base station 105. In some examples, the RRC connection request message may include a series of UE radio capability bits advertising at least one or more UE capabilities to the base station 105.

In response to the RRC connection request message, the base station 105, at 206, may respond with RRC connection setup message to the UE 115-a. In some examples, the RRC connection setup message may be used to establish a signal bearer and contain configuration information for establishing the signal bearer. In other aspects, the RRC connection setup message may include configuration information for physical uplink shared channel (PUSCH), physical uplink control channel (PUCCH), physical downlink shared channel (PDSCH) and information regarding uplink power control, channel quality indicator (CQI) report, and/or antenna configuration.

Upon receiving the RRC connection setup 206, the communication management component 30, at block 208, may initiate UE capability identification procedures. In some examples, UE capability identification procedures may include identifying one or more capabilities supported by the UE 115 and generating a connection setup message (e.g., RRC connection setup complete message). In accordance with aspects of the present disclosure, the communication management component 30 may additionally estimate the time for transmitting the connection setup message over at least one uplink channel to the base station 105. If the communication management component 30 determines that the estimated time of transmission exceeds a threshold, the connection setup message may be modified for transmission. Alternatively, if the communication management component 30 determines that the estimated time of transmission is below a threshold, the connection setup message may be transmitted to the base station 105 without undergoing any modification. In one or more examples, the threshold may comprise a first threshold value associated with a non-emergency call (e.g., non-emergency call threshold 124) and a second threshold value associated with an emergency call (e.g., emergency call threshold 126).

Accordingly, the UE 115, at 210, may transmit a modified RRC connection setup complete message to the base station 105. The modified RRC connection setup complete message 210 may include one or more of START_PS, UE radio capability, and inter-RAT UE capabilities. In some aspects, UE capability may include UE radio capabilities, UE NAS capabilities, and classmark information. Classmark information may be used for circuit switched (CS) domain. Additionally or alternatively, UE radio capabilities may include UE GSM/EDGE radio access network (GERAN) capability, UE UTRAN capability and UE E-UTRAN capability. In yet further examples, UE NAS capabilities include UE network capability and MS network capability.

Thus, in accordance with the present disclosure, transmitting the modified RRC connection setup complete message 210 may comprise trimming a portion of the RRC connection setup complete message 210 based on the determining that the estimated time to transmit is above the threshold (e.g., emergency call threshold and/or non-emergency call threshold). In some examples, trimming the portion of the connection setup message may comprise removing at least one of the above identified UE capability information from the connection setup message. Trimming may also comprise selecting one or more portions of the connection setup message for transmission to the base station 105. In this regard, the remaining portion of the connection setup message is not transmitted to the base station 105. Additionally or alternatively, in some examples, trimming the portion of the connection setup message may comprise removing UE E-UTRA capability information element from the RRC connection setup complete message 210. Thus, in one aspect, for example, at least a portion of UE capability is not reported in the modified RRC connection setup complete message 210.

Based on the transmission of the modified RRC connection setup complete message 210, the UE 115 and the base station 105, at 212, may establish RRC communication for subsequent transmission and reception of data packets. In some examples, following an establishment of RRC communication 212 between the UE 115 and the base station 105, the network (e.g., RNC) or the UE 115 may initiate UE capability enquiry. In some aspects, the UE 115-a, at 214, may transmit complete UE capability information message to the base station 105 following an establishment of RRC communication. Thus, the UE 115 may advertise complete UE capability information if the RRC connection setup complete message was originally modified by trimming or otherwise removing at least a portion of the UE capability information. Additionally or alternatively, the base station 105 may transmit a UE capability confirm message 216 back to UE 115 based on receiving the RRC connection setup message.

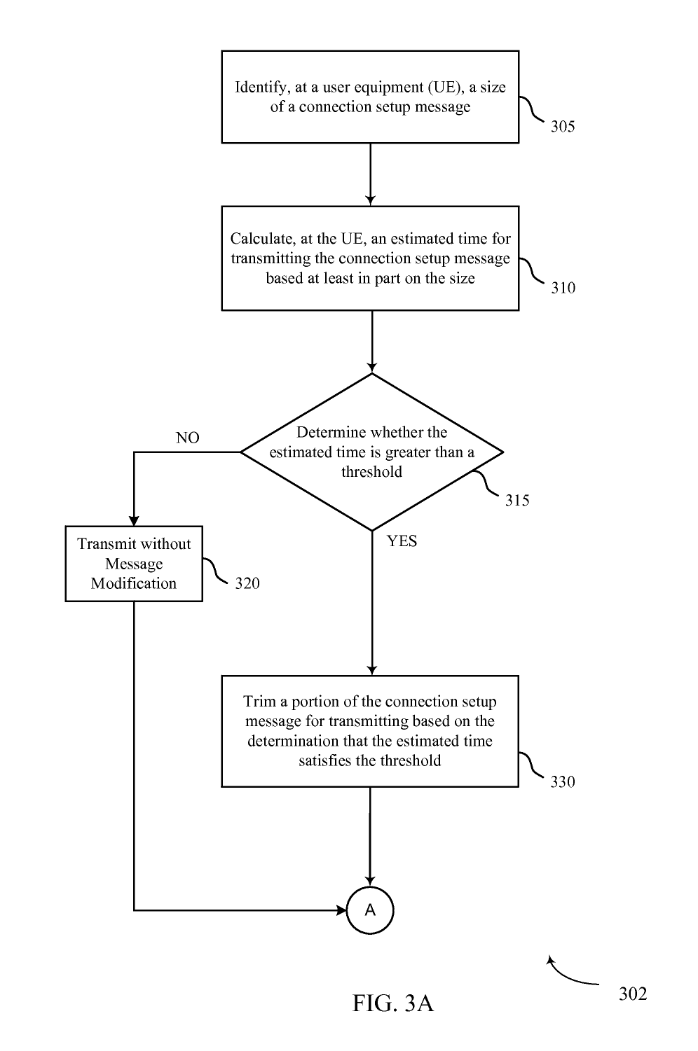

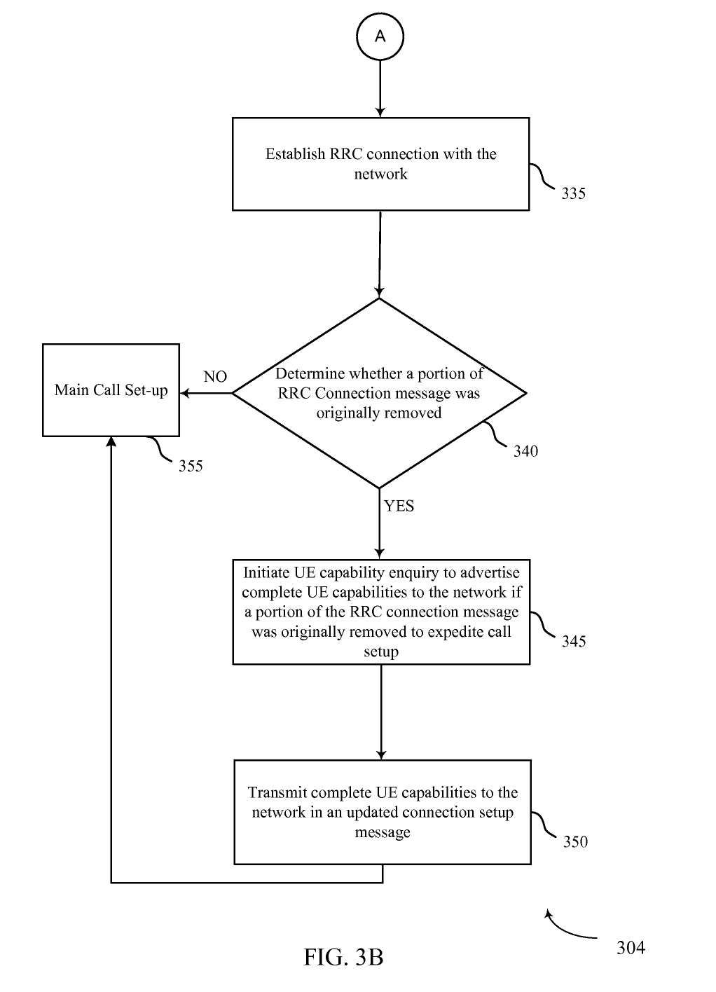

FIG. 3A shows a detailed flowchart illustrating a method 302 for handling over-sized call setup messages in accordance with various aspects of the present disclosure. In some examples, the method 302 may be an example of UE capability identification procedures 208 described with reference to FIG. 2.

In some examples, the UE 115, during RRC connection setup procedures, may identify one or more UE capabilities supported by the UE 115. Based on the identified UE capabilities, the UE 115 may generate a connection setup message (e.g., RRC connection setup complete message) that comprises one or more UE capability information elements. At block 305, the UE 115 may identify a size of the connection setup message generated by the UE based on the identified UE capabilities. Aspects of block 305 may be performed by the UE capability component 32, which is described with reference to FIG. 1A.

At block 310, the UE 115 may calculate an estimated time for transmitting the connection setup message over at least one uplink channel based at least in part on the identified size of the connection setup message. In some examples, aspects of block 310 may be performed by transmission estimation component 34 described with reference to FIG. 1A.

At block 315, the UE 115 may determine whether the estimated time is greater than or less than a threshold. The threshold may be predetermined threshold or dynamically adaptable threshold. In some examples, the threshold may be determined based on the type of call (e.g., emergency call or non-emergency call) that the UE 115 may be attempting to setup. For instance, the threshold may comprise a first threshold value associated with a non-emergency call and a second threshold value associated with an emergency call. Thus, in some examples, the UE 115 may determine whether the estimated time is greater than a threshold based on the type of call setup. Aspects of block 315 may be performed by threshold determination component 36, which is described with reference to FIG. 1A.

If the UE 115 determines that the estimated time to transmit the connection setup message is less than the threshold (e.g., first threshold or the second threshold), the UE 115, at block 320, may transmit the connection setup message without modifying the connection setup message. However, if at block 315, the UE 115 determines that the estimated time is greater than the threshold, the UE 115 may forward the connection setup message to the message trimming component to remove or modify the connection setup message. In some examples, removing or modifying the connection setup message may include trimming a portion of the connection setup message. Aspects of block 315 may be performed by the transmission estimation component 38 in connection with the threshold determination component 37, which is described with reference to FIG. 1A.

If the UE 115, at block 315 determines to trim the connection setup message, the UE 115 may trim a portion of the connection setup message based on the determining that the estimated time is greater than the threshold. In some examples, trimming the portion of the connection setup message may comprise removing at least one of the identified UE capability information from the connection setup message. Additionally or alternatively, in some examples, trimming the portion of the connection setup message may comprise removing UE E-UTRA capability information element from the RRC connection setup complete message. Thus, in one aspect, for example, at least a portion of UE capability may not be reported in the modified connection setup message. Aspects of block 330 may be performed by the message trimming component 38 described with reference to FIG. 1A.

FIG. 3B shows a detailed flowchart illustrating a method 304 for handling over-sized call setup messages in accordance with various aspects of the present disclosure. In some examples, the method 304 may be a continuation of method 302 described with reference to FIG. 3A.

In some aspects, the UE 115, at block 335, may establish an RRC connection based on the partial advertisement of UE capabilities (see FIG. 3A). Partial advertisement of UE capabilities may be based on trimming a portion of the connection setup message where at least one of the identified UE capability information may be removed from the connection setup message. Additionally or alternatively, in some examples, trimming the portion of the connection setup message may comprise removing UE E-UTRA capability information element from the RRC connection setup complete message. Thus, in one aspect, for example, at least a portion of UE capability may not be reported in the modified connection setup message. Accordingly, the RRC connection may be established between the UE 115 and the network based on partial UE capability information.

At block 340, the UE 115 may determine whether a portion of RRC connection message was originally removed (e.g., trimmed) to accommodate expedited RRC connection setup. If, at block 340, the UE 115 determines that at least a portion of the original RRC connection message transmitted to the base station was not removed, the UE 115 may maintain its established network connection with the base station. However, if, at block 340, the UE 115 determines that at least a portion of RRC connection message was originally removed, the UE 115 may proceed to block 345.

At block 345, the UE 115, following a period of time, may initiate UE capability enquiry to advertise its full capabilities to the network. In one or more examples, initiating UE capability enquiry may comprise transmitting UE capability information message 214 to the network (see FIG. 2). Aspects of block 345 may be performed by UE capability component 32 described with reference to FIG. 1A.

At block 350, the UE 115 may transmit the complete UE capability information to the network in an updated connection setup message. In some example, transmitting the complete UE capability information may comprise transmitting the portion of UE capability that was previously not reported in the modified connection setup message. Additionally or alternatively, the updated connections setup message may include UE capability information elements previously reported to the network in the modified connection setup message in conjunction with UE capability information elements previously not reported to the network. As a result, the UE 115 may modify its RRC connection based on a complete knowledge of capabilities supported by the UE 115. Aspects of block 350 may be performed by one or more transceivers.

The detailed description set forth above in connection with the appended drawings describes example embodiments and does not represent all the embodiments that may be implemented or that are within the scope of the claims. The term “exemplary,” as used in this description, means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or “as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, electrically erasable programmable read only memory (EEPROM), compact disk (CD) ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of Universal Mobile Telecommunications System (UMTS) that use E-UTRA. UTRA, E-UTRA, UMTS, LTE, LTE-A, and Global System for Mobile Communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description above, however, describes an LTE system for purposes of example, and LTE terminology is used in much of the description above, although the techniques are applicable beyond LTE applications.

What is claimed is:

1. A method for wireless communication, comprising:
identifying, at a user equipment (UE), a size of a connection setup message;
calculating, at the UE, an estimated time for transmitting the connection setup message based at least in part on the size;
determining whether the estimated time is greater than the threshold; and
trimming a portion of the connection setup message for transmitting based on the determination that the estimated time is greater than the threshold.

2. The method of claim 1, wherein trimming the portion of the connection setup message comprises:
removing at least one UE capability information from the connection setup message.

3. The method of claim 1, wherein trimming the portion of the connection setup message comprises:
removing at least one UE evolved universal terrestrial radio access (E-UTRA) capability information element from the connection setup message.

4. The method of claim 1, further comprising:
transmitting a partial connection setup message comprising a remaining portion of the trimmed connection setup message from the UE to a network device.

5. The method of claim 4, further comprising:
establishing a connection with a network; and
initiating UE capability enquiry to advertise complete UE capabilities to the network when the connection setup message is trimmed.

6. The method of claim 4, wherein the partial connection setup message includes a limited set of UE capability information.

7. The method of claim 1, wherein calculating the estimated time for transmitting the connection setup message comprises:
determining a characteristic of an uplink transport channel; and
calculating the estimated time to transmit the connection setup message on the uplink transport channel based on the characteristic.

8. The method of claim 1, wherein the threshold comprises a first threshold value associated with a non-emergency call and a second threshold value associated with an emergency call.

9. The method of claim 1, wherein the connection setup message is a radio resource control (RRC) connection setup message.

10. An apparatus for wireless communications, comprising:
means for identifying, at a user equipment (UE), a size of a connection setup message;
means for calculating, at the UE, an estimated time for transmitting the connection setup message based at least in part on the size;
means for determining whether the estimated time is greater than the threshold; and
means for trimming a portion of the connection setup message for transmitting based on the determination that the estimated time is greater the threshold.

11. The apparatus of claim 10, wherein the means for trimming the portion of the connection setup message comprises:
means for removing at least one UE capability information from the connection setup message.

12. The apparatus of claim 10, wherein the means for trimming the portion of the connection setup message comprises:
means for removing at least one UE evolved universal terrestrial radio access (E-UTRA) capability information element from the connection setup message.

13. The apparatus of claim 10, further comprising:
means for transmitting a partial connection setup message comprising a remaining portion of the trimmed connection setup message from the UE to a network device.

14. The apparatus of claim 13, further comprising:
means for establishing a connection with the network; and
means for initiating UE capability enquiry to advertise complete UE capabilities to the network when the connection setup message is trimmed.

15. The apparatus of claim 13, wherein the partial connection setup message includes a limited set of UE capability information.

16. The apparatus of claim 11, wherein the means for calculating the estimated time for transmitting the connection setup message comprises:
means for determining a characteristic of an uplink transport channel; and
means for calculating the estimated time to transmit the connection setup message on the uplink transport channel based on the characteristic.

17. The apparatus of claim 11, wherein the threshold comprises a first threshold value associated with a non-emergency call and a second threshold value associated with an emergency call.

18. The apparatus of claim 11, wherein the connection setup message is a radio resource control (RRC) connection setup message.

19. An apparatus for wireless communication, comprising:
a transceiver configured to transmit uplink data transmissions on an uplink channel, and to receive responses corresponding to the uplink data transmissions;
a memory configured to store code with instructions; and
at least one processor communicatively coupled to the memory and the transceiver via a bus, the at least one processor configured to execute the code to:
identify, at a user equipment (UE), a size of a connection setup message;
calculate, at the UE, an estimated time for transmitting the connection setup message based at least in part on the size;
determine whether the estimated time is greater than a threshold; and
trim a portion of the connection setup message for transmitting based on the determination that the estimated time is greater than the threshold.

20. The apparatus of claim 19, wherein the at least one processor is further configured to:
remove at least one UE evolved universal terrestrial radio access (E-UTRA) capability information element from the connection setup message.

21. The apparatus of claim 20, wherein the transceiver is further configured to:
transmit a partial connection setup message comprising a remaining portion of the trimmed connection setup message from the UE to a network device.

22. The apparatus of claim 21, wherein the partial connection setup message includes a limited set of UE capability information.

23. The apparatus of claim 19, wherein the at least one processor is further configured to:
establish, via the transceiver, a connection with the network; and
initiate UE capability enquiry to advertise complete UE capabilities to the network when the connection setup message is trimmed.

24. A computer-readable medium storing code for wireless communications, comprising: the code comprising instructions executable to:
code for identifying, at a user equipment (UE), a size of a connection setup message;
code for calculating, at the UE, an estimated time for transmitting the connection setup message based at least in part on the size;
code for determining whether the estimated time is greater than a threshold; and
code for trimming a portion of the connection setup message for transmitting based on the determination that the estimated time is greater than the threshold.

25. The computer-readable medium of claim 24, wherein the code for trimming the portion of the connection setup message comprises:
code for removing at least one UE capability information from the connection setup message.

26. The computer-readable medium of claim 25, further comprising:
code for transmitting a partial connection setup message comprising a remaining portion of the trimmed connection setup message from the UE to a network device.

27. The computer-readable medium of claim 26, wherein the partial connection setup message includes a limited set of UE capability information.

28. The computer-readable medium of claim 24, wherein the code for trimming the portion of the connection setup message comprises:
code for removing at least one UE evolved universal terrestrial radio access (E-UTRA) capability information element from the connection setup message.

29. The computer-readable medium of claim 24, further comprising:
means for establishing a connection with the network; and
means for initiating UE capability enquiry to advertise complete UE capabilities to the network when the connection setup message is trimmed.

30. The computer-readable medium of claim 24, wherein the threshold comprises a first threshold value associated with a non-emergency call and a second threshold value associated with an emergency call.
